(19) United States
(12) Patent Application Publication
(10) Pub. No.: US 2014/0201286 A1
(43) Pub. Date: Jul. 17, 2014

(54) ATTACHING SUPPLEMENTAL INFORMATION TO OBJECTS AND CONTENT USING MARKERS

(71) Applicant: Jari Kristensen, Kirkland, WA (US)

(72) Inventor: Jari Kristensen, Kirkland, WA (US)

(21) Appl. No.: 14/158,473

(22) Filed: Jan. 17, 2014

Related U.S. Application Data
(60) Provisional application No. 61/753,662, filed on Jan. 17, 2013.

(51) Int. Cl. H04L 29/06

(52) U.S. Cl. CPC H04L 65/403
USPC 709/204

(57) ABSTRACT

An information attachment system is described herein that attaches supplemental information to objects or digital content so that any party interested in those objects or content will go to the same place to find the supplemental information shared by others. Most objects have numerous interested parties that will interact with the object. Manufacturers and authors often place markers on objects and content for their own purposes. However, other interested parties also have information related to the object or content that they want to share. The system allows interested parties, often other than the original content author or manufacturer of the object, to associate information with the object by leveraging markers placed on the object by the manufacturer or original content author. In this way, the original marker serves as a kind of meeting place for all of the interested parties to share information.

### CROSS-REFERENCE TO RELATED APPLICATIONS

The present application claims the benefit of U.S. Provisional Patent Application No. 61/753,662 (Attorney Docket No. JARI001) entitled “THIRD PARTY AUGMENTING OF ONLINE CONTENT,” and filed on Jan. 17, 2013, which is hereby incorporated by reference.

### BACKGROUND

The world is full of many types of real world objects and digital content. Objects may include stores, books, cars, food items, clothing, items sold at retail, items sold online, items owned by a purchaser, and any other item with which a person can interact. Digital content may include web pages, videos, digital music, e-books, and other types of digital information consumed by users. Digital content may be stored on the internet, stored privately on a user's computing device (e.g., laptop, smartphone, tablet, or other device), stored on physical media, and so forth. Often these objects and content are the subject of sales transactions, and there may be many interested parties that interact with the objects and content over time. For example, a book may be sold by a local book retailer, reviewed by a critic for a newspaper, purchased by one or more consumers, selected by one or more book clubs, and so forth. Although some items may not be sold, such as a piece of artwork that an artist gives as a gift, these items still have many interested parties, such as the artist, the recipient, others who see and have an opinion about the art, and so forth.

Many real world objects and digital content items contain markers that are used to manually or electronically identify and/or provide information about the objects or content with which the markers are associated. Examples of common markers include bar codes, quick response (QR) codes, product model numbers, brand logos, and any other type of identifying mark that can be attached to or associated with an object. These markers are placed on the objects or content by the object manufacturer or content author. For example, products for sale in a grocery store have long required the inclusion of a scan-able bar code that defines a stock keeping unit (SKU) that uniquely identifies each product. This allows grocery stores to install electronic devices for reading the bar codes to quickly ring up a set of items purchased by a consumer. Similarly, in recent times QR codes have emerged as a popular way to place a marker on an object or content, and QR code reading applications have been produced for smartphones and other computing devices that read embedded links to additional content from the content author or object manufacturer that placed the QR code on the object or digital content.

The problem with these types of markers and the available information that they are designed to convey is that they are universally placed on or associated with the objects or content by the manufacturers or content authors, and they serve only the purposes intended by those parties. Left out of the interaction with these objects and content are the numerous other interested parties, such as retailers, potential purchasers, reviewers, government agencies, professionals (e.g., a doctor with a medical opinion of a products efficacy), and so on. A product is sold with or placed into the world with the information on it that the manufacturer or author intends, and other interested parties are left with loosely connected third party services to share their information related to the objects or content. For example, a user that wants to provide an opinion of a product might use a third party website such as http://www.epinions.com/ to provide a review or opinion about a product. However, with no direct association to the product, the user can have no measure of certainty that others interested in the product will ever know about or find his or her review. As another example, a retailer that wants to offer a sale on a product may post that information separately near the product on a shelf (e.g., with a paper sign). Although those that walk by the product are more certain in this example to see the information, the retailer is on his or her own to get this information out into the world, such as through direct mailings or a website, and the information the retailer wants to share is in an inferior position to the manufacturer's own product information.

### BRIEF DESCRIPTION OF THE DRAWINGS

FIG. 1 is a block diagram that illustrates components of the information attachment system, in one embodiment.

FIG. 2 is a flow diagram that illustrates processing of the information attachment system to attach supplemental information to an object using a marker previously associated with the object, in one embodiment.

FIG. 3 is a flow diagram that illustrates processing of the information attachment system to read supplemental information attached to an object, in one embodiment.

FIG. 4 is a display diagram that illustrates a user interface of the information attachment system for attaching supplemental information to an object or content identified by a marker, in one embodiment.

FIG. 5 is a display diagram that illustrates a user interface of the information attachment system for displaying supplemental information attached to an object or content identified by a marker, in one embodiment.

### DETAILED DESCRIPTION

An information attachment system is described herein that attaches supplemental information to real world objects or digital content in a manner that any party interested in those objects or content are very likely to go to the same place to find the supplemental information shared by others. Most objects have numerous interested parties that will interact with the object in some way. For example, a car for sale has a manufacturer, a dealer, potential buyers, government regulators, reviewers, safety testers, and others that are all interested in the car in some way. A manufacturer typically places a sticker on a car that details the cars features, suggested retail price, and other information. The manufacturer may also place a QR code or other marker on the sticker, through which the manufacturer expects potential buyers to be able to find additional information about the vehicle on a website. However, other interested parties also have a relationship with the car, and information they may like to share or convey. For example, a dealer may be having a local sale, and may want to share promotional offers. A potential buyer may have a comment about something he or she noticed about the car that he or she would like to share with other potential buyers. The system allows interested parties, often other than the original content author or manufacturer of the object, to associate information with the object by leveraging markers already placed on the object by the manufacturer or original content author. In this way, the original marker serves as a kind of meeting place or junction for all of the interested parties to share and associate information.

Although a car is used in the previous example, it should be noted that the system is powerful enough to work with any type of object or content. For example, a frozen turkey sold by a grocery store is no different from a car in this respect. The turkey packaging may contain a bar code, QR code, or other marker, and numerous parties may have some interest in the item. For example, a grocery store owner that sells the turkey may want to share specials or coupons available for saving money on the turkey or on related items. People who have bought that brand of turkey before may want to share reviews related to flavor, meat quality, or other aspects of the turkey. Buyers may also want to share recipes that include the turkey as an ingredient. As another example, content, such as a web page, may be the subject of interested parties. For example, people may want to comment on the content of a web page that does not provide its own comment function. The system can be used to associate these types of information, without any consent or involvement from the content author. Thus, the information attachment system empowers parties in addition to the object manufacturer or content author to interact richly with other parties and to share information in a manner that becomes directly associated with the object or content itself, sometimes through markers already available on the object.

The above examples demonstrate mostly public types of sharing (e.g., supplemental information that is made available to everybody that wants to see it), but the information attachment system also includes other levels of sharing. Information associated with an object may be shared privately only to a single user, privately to a select group of users (e.g., a family, co-workers, members of a club, a particular demographic group, and so forth), or via any other scheme of sharing desired by a user. For example, in the example of the turkey above, a person that has bought the turkey before may want someone in his or her family to pick up another turkey at the grocery store. The father in this family may make the request, and the system may make this supplemental information available to all family members. Based on appropriate context, such as one of the family members entering a grocery store as determined by location data, the system may share the supplemental information to provide the family member with a grocery list of requested items, including the turkey. In this example, supplemental information is not just interesting, but it is also actionable.

In some embodiments, the information attachment system leverages location-based information to enhance the operation of the system. For example, the system may associate particular types of supplemental information associated with an object with particular locations where that information is more relevant. In the example above, the information that one family member needed an item at the grocery was made more relevant when another family member was at a grocery, and the system bubbled that information to the surface at the appropriate time by using location-based information. Most mobile computing devices today, such as smartphones, include one or more types of location-determining hardware. For example, global positioning system (GPS) hardware is often included in mobile devices. In addition, Wi-Fi hardware can also be used to determine location, using techniques such as known hotspots and triangulation of known signal strengths to recognized hotspots. Through these and other techniques that are known in the art, the system can determine a user's location and use location information at appropriate times for sharing information associated with one or more objects or content items. Location can be relevant for both the person sharing the information and those receiving the information. In the previous example, the location was relevant to the recipient, but consider opinions shared at a historical site, at which a recipient may want to view previous comments made while sharers were at that location. In this example, the sharer's location is relevant.

The information attachment system depends on a clear identification of a particular instance of or type of an object or content. In some cases, this identification occurs through markers that have often been placed on the object for other purposes. In one sense, the system repurposes these markers in order to attach supplemental information to the object. Markers may include a bar code, QR code, model number, uniform resource locator (URL), or any other type of information that allows an object or content to be recognized. In advanced versions of the system, even image recognition and analysis may be used to identify an object without any other type of marker present. For example, some embodiments of the system may use image analysis to recognize that a picture of a can of soda is from COCA COLA TM, and then to associate supplemental information with that object.

Markers can be read in a variety of ways, using available hardware of mobile or other computing devices. For example, many types of markers can be read with a digital camera, available on most mobile computing devices. For example, most smartphones can use the camera included in the device to read bar codes, read QR codes, recognize text, recognize images, and so forth. In some embodiments, the system may leverage other types of devices and available hardware of particular systems, such as a laser-based barcode reader. The system is not limited to any one manner of identifying and reading markers to identify objects. Rather, the system recognizes that almost any object has some identifying type of marker that can be leveraged to associate the types of supplemental information with the object expected by users of the system. In some embodiments, an object may even be a person's face, and the system may recognize faces using a digital camera. The power of the system can then be leveraged to attach all kinds of supplemental information from all kinds of interested parties to a particular person's identity. Career information from sites like LinkedIn, social media information from sites like Facebook, medical history associated by a doctor and shared privately between doctor and patient, may all be associated with a person who in this example is the object that is the subject of the supplemental information attached by the system.

In some embodiments, the information attachment system provides one or more software applications for performing the functions described herein. For example, the system may provide at least one application for attaching supplemental information to objects and at least one application for consuming supplemental information attached to objects. In some cases, these may be the same application. Applications may be designed for mobile platforms, such as a smartphone or tablet application (e.g., targeting iOS, Android, Windows Mobile, or other operating systems), desktop platforms, information kiosks, set top boxes, or any other type of computing platform. Software applications provided by the system may be run manually by the user, such as when the user sees an object to which the user wants to attach supplemental information, or may be run automatically, such as through a geo-fence that invokes the application based on a location at which the user arrives or at other relevant times.

The information attachment system may create its own concepts of social circles and/or may leverage social circles already defined elsewhere. Each person is involved in many different loosely or strictly defined groups. For example, a person may be an employee of a particular company, and thus belong to a group that includes all employees of that company. A person is also a member of a particular neighborhood, a member in a family where the family may include subgroups of immediate and extended family, a member of particular demographic groups (e.g., all males, all people between age 20 to 30, and so forth), a member of various clubs, an alumni of various schools, and so forth. The system may leverage any of these types of social circles to define how broadly supplemental information attached to objects or content is shared. In some cases, a user may need to be a member of a particular social circle in order to view information shared privately to that social circle about an object or content. For example, information shared about a person's medical history may be limited to the social circle of doctor and patient. Information shared about products in a retail store may be limited to shoppers at that retail store. Information shared with family members may be limited to viewing by only members of the family.

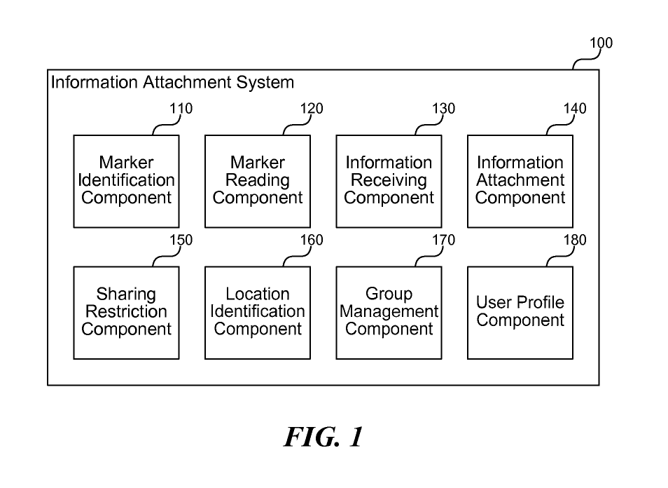

FIG. 1 is a block diagram that illustrates components of the information attachment system, in one embodiment. The system 100 includes a marker identification component 110, a marker reading component 120, an information receiving component 130, an information attachment component 140, a sharing restriction component 150, a location identification component 160, a group management component 170, and a user profile component 180. Each of these components is described in further detail herein.

The marker identification component 110 finds and identifies one or more markers near a user that identify particular objects and content. In some cases, the requests identifying a marker, such as by opening an application on the user's mobile phone and pointing the phone's digital camera at the marker on an object. In other cases, the system may automatically (potentially continually) identify markers around the user. For example, with devices such as GOOGLE TM GLASS TM, the user may be wearing a camera and other computing hardware that is capturing information about the world around the user all the time. Such devices can be instructed through software to find and identify markers that are around the user, so that the user can then attach supplemental information to the objects and content with which the markers are associated.

The marker reading component 120 determines one or more objects or content items with which identified markers are associated. For example, after the marker identification component 110 has found and identified a QR code on an automobile price sticker, the marker reading component 120 determines what the QR code originally linked to and that the object the QR code is associated with is a particular make and model of vehicle. The marker reading component 120 may consult a database or other data store maintained by the system 100 for looking up and identifying objects. For some types of markers, such as QR codes, there is information embedded in the marker itself that is machine readable to extract information that can be helpful for identifying the object or content with which the marker is associated. In some embodiments, the system may ask the user what object the marker is associated with, such as for objects or content that has not previously been identified by any user or operator of the system 100.

The information receiving component 130 receives supplemental information from a user of the system that the user wants to associate with an identified object or content item. The information may include text, photos, video, audio, or any other form of information that the user finds relevant to the identified object or content item and wants to associate therewith. In some embodiments, the system may prompt the user for additional information that the user may not have thought of on his or her own. For example, if the user identifies a marker on a vehicle, the system may ask the user for the vehicles color and/or vehicle identification number (VIN), so that information can be stored to identify the object along with other supplemental information provided by the user. The user may type information on a mobile computing device, such as a smartphone, or may input information in other ways provided by a software application provided by the system, such as voice recognition, video or audio recording, and so forth. In some embodiments, the system may automatically capture additional information, such as location information obtained by invoking the location identification component 160.

The information attachment component 140 associates the supplemental information received from the user with the identified object or content item to attach and create a direct association between the two. This association is what allows subsequent users of the system 100 that identify the same object to view supplemental information shared by previous users. The information attachment component 140 may store the received supplemental information in a database or other data store associated with the system 100. For example, the system 100 may include a database with a table of all known objects, and may include another table with rows that include mappings between received supplemental information and an object defined by a row in the table of objects. The system 100 may contain potentially many such rows for each object, each representing all of the supplemental information shared by various users of the system 100 over time.

The sharing restriction component 150 defines a sharing level for received supplemental information that determines which other users of the system will be allowed by the system to view the received supplemental information. Supplemental information may be public (i.e., shared with everyone) or private (i.e., shared with a limited group of users). The sharing restriction component 150 stores with each instance of supplemental information restriction data that indicates how widely the user providing the information wants the information shared with other users. The restriction data may specify that the supplemental information is public (and thus unrestricted), or may identify particular users, groups, or social circles that are permitted to view the supplemental information. Sharing restrictions may also have other dimensions in addition to user identity. For example, supplemental information may have a time component that specifies a time-based expiration after which the supplemental information is no longer viewable. As another example, supplemental information may have a location component so that the information is only viewable by users within a particular proximity of a given location. Sharing restrictions help to keep the information displayed to a user at any given time relevant, and operate to preserve the privacy of the user that shared the information.

The location identification component 160 determines a user's location and provides this information for determining how supplemental information is shared with other users of the system. The component 160 may identify location data of both sharing users and users requesting to view shared supplemental information. For sharing users, the system 100 may store the determined location of the sharing user along with supplemental information that the sharing user provides, so that the sharing user's location can be used to determine how the supplemental information is shared with other users. For users requesting to view shared supplemental information, the system 100 may use their determined location to find supplemental information that is relevant to their current location. The location identification component 160 may include GPS, Wi-Fi, Bluetooth, or other hardware of a computing device carried and/or used by the user(s), as well as software of the system for receiving and working with the location information provided by hardware.

The group management component 170 manages social circles of users that have one or more connections to each other and manages sharing of received supplemental information within each managed social circle. A social circle may include numerous types of manually and automatically defined groups of users, such as family members, coworkers, people of a certain security clearance, people with a particular job title, people in a particular neighborhood or country, and so forth. Social circles may be ongoing, such as membership in a family, or temporary, such as people currently buying gas or shopping in a particular grocery store. The group management component 170 manages these groups so that they can be used to specify how supplemental information is shared. For example, if a sharing user wants to share some information about an object with his or her coworkers, the component 170 determines who the sharing user's coworkers are and handles requests for the information to allow those made by members of the desired group and reject those requests made by non-members of the group.

The user profile component 180 stores and provides access to profile information for each user of the system. The system may store information related to users in a database or other data store associated with the system. Users may logon to the system using a username and password or other authentication information, and the system 100 may associate each user's activities with a stored profile for the user. The profile may include other information, such as a user's contact information, which social circles or groups the user is a member of, a history of supplemental information shared by the user, and so forth. The system 100 invokes the user profile component 180 when supplemental information is shared or requested to store information about the user sharing the information or to restrict access to requested supplemental information to the right set of users.

The computing device on which the information attachment system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

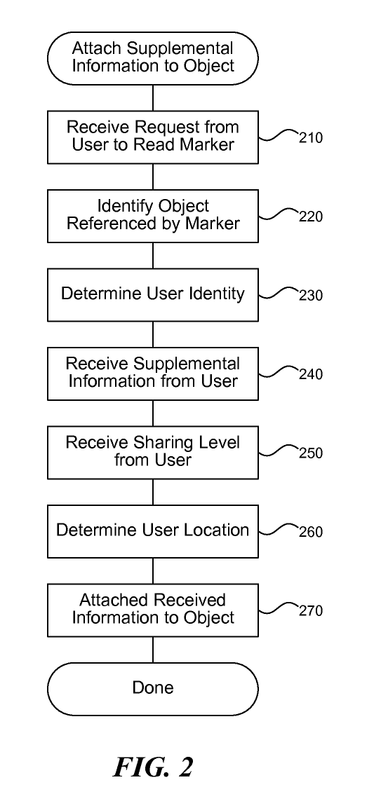

FIG. 2 is a flow diagram that illustrates processing of the information attachment system to attach supplemental information to an object using a marker previously associated with the object, in one embodiment.

Beginning in block 210, the system receives a request from a user to read a marker. The user may be shopping, at home, at work, or somewhere else and identify an object or content that the user wants to interact with by adding supplemental information to or reading supplemental information added by others. The system may be invoked by the user reaching for his or her smartphone or other computing device, invoking a software application that implements parts of the system, and selecting a user interface control for reading a marker. The user may then aim the computing device's digital camera at the marker so that the software application can capture an image of the marker and analyze the captured image to recognize the marker. Recognition may include reading a bar code, reading a QR code, recognizing text (e.g., via optical character recognition (OCR)), recognizing objects in the image, recognizing one or more faces in the image, and so forth.

Continuing in block 220, the system determines an object associated with the marker. In some embodiments, the system maintains a database or other data store, and may interface with third party databases and data stores for identifying objects associated with markers. For example, databases are available that catalog bar codes of products such that the system can match an identified bar code marker with the product associated with the bar code. Similarly, the system can build or access a database that maps QR codes to the objects or content to which they refer. In the case of image or facial recognition, the system may maintain an index of facial or image data that can be used to map points within a captured image to data stored for known objects. From this process, the system identifies a specific object or content item with which the user is currently interacting.

Continuing in block 230, the system determines the user's identity. Identity may be determined by the user logging into a software application, either manually such as by providing a username and password, or automatically via previously stored security credentials of the user. In some embodiments, the system may recognize the user's computing device, such as via a device identifier, a media access control (MAC) address of networking hardware, or other substantially unique identifier. Knowing the user's device the system can then infer the user associated with the device. The user's identity may be useful for various reasons. If the user requests to restrict access to particular groups (e.g., “my family”) then knowing the user's identity identifies the group of users that belong to the group. The system may also store the user identity of each user that stores content for other purposes, such as to give credit to users for their contributions, to respond to copyright takedown requests, or any other purpose.

Continuing in block 240, the system receives supplemental information from the identified user related to the determined object. The information may comprise any type of information relevant to the user, such as user comments, a review of the object, images of the object, a request related to the object (e.g., the user wants to purchase the object), or any other type of information. The user may type the information on a physical or virtual keyboard, capture the information with hardware of the user's computing device (e.g., a digital camera, microphone, GPS hardware, or other), or use other methods available in the art for capturing information. In some embodiments, the system may define particular types of information to be captured. For example, the system may allow one party to leave a survey attached to an object for other parties that encounter the object to complete. For example, a car dealer may want to capture opinions of potential buyers that view or test-drive a car. In this example, the system may prompt the user with specific questions for the user to answer or fields for the user to fill in.

Continuing in block 250, the system receives a sharing level from the user that determines which other users will be able to view the received supplemental information. The sharing level may be “public”, in which case the supplemental information is available to all users of the system, or “private”, in which case the supplemental information is restricted to a particular set of users. The set of users may include a single user (such as the user that provided the information making notes for the user's own purposes), another user (such as a friend that the user wants to share information with), a group of users (such as family members, coworkers, neighbors, or others), or any other sharing level desired by the user. The system may provide a predefined set of social circles, such as known members of the user's family or coworkers employed by the user's employer, may access third party services that define social groups (e.g., Facebook, Twitter, or others), or may receive a specific list of users from the user.

Continuing in block 260, the system optionally determines the user's location where the supplemental information was received. Location may be determined by accessing location hardware of the user's mobile computing device, such as GPS hardware, Wi-Fi hardware, Bluetooth hardware, or other methods. The system associates the determined location with the received supplemental information. Location information may be relevant at the time of viewing supplemental information attached to an object. For example, a user may request to see supplemental information from other users that visited the same spot (e.g., a historical place, particular store, or other significant location). Location data may also be useful for other reasons. For example, a user may want to see where he or she has shared supplemental information in the past, or the system may restrict viewing of the information based on the location of the user requesting the information.

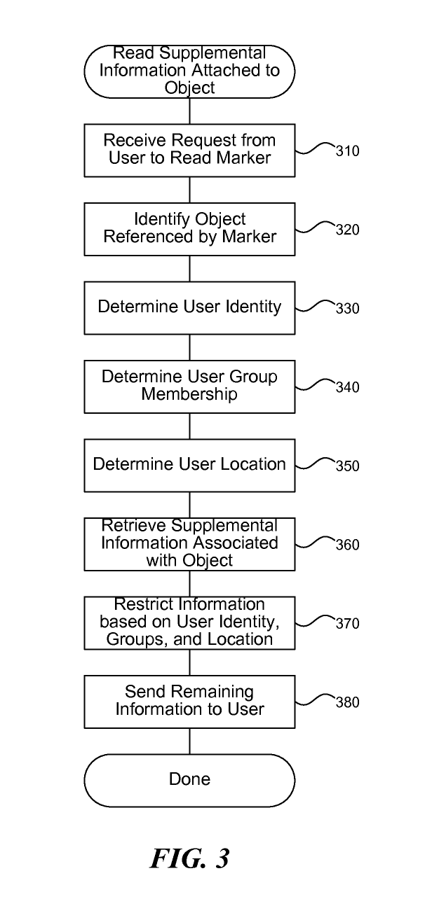

Continuing in block 270, the system attaches the received information to the object by storing the supplemental information and identified object information in a data store where other users can potentially access it. The system also stores any received sharing level, location data, or other information. The system may maintain a database, cloud-based data store, or other data store of received supplemental information. The system may receive many types of supplemental information, such as unsolicited information from end users, sponsored information from retailers, or other types of information from other parties. Once the system stores the supplemental information it can then be accessed by other users of the system, in accordance with any restrictions placed on the information by the sharing level or location, as described further with reference to FIG. 3. After block 270, these steps conclude.

FIG. 3 is a flow diagram that illustrates processing of the information attachment system to read supplemental information attached to an object, in one embodiment.

Beginning in block 310, the system receives a request from a user to read a marker. The user may be shopping, at home, at work, or somewhere else and identify an object or content that the user wants to interact with by reading supplemental information attached to the object by the user or other users. The system may be invoked by the user reaching for his or her smartphone or other computing device, invoking a software application that implements parts of the system, and selecting a user interface control for reading a marker. The user may then aim the computing device's digital camera at the marker so that the software application can capture an image of the marker and analyze the captured image to recognize the marker. Recognition may include reading a bar code, reading a QR code, recognizing text (e.g., via optical character recognition (OCR)), recognizing objects in the image, recognizing one or more faces in the image, and so forth.

Continuing in block 320, the system determines an object associated with the marker. In some embodiments, the system maintains a database or other data store, and may interface with third party databases and data stores for identifying objects associated with markers. For example, databases are available that catalog bar codes of products such that the system can match an identified bar code marker with the product associated with the bar code. Similarly, the system can build or access a database that maps QR codes to the objects or content to which they refer. In the case of image or facial recognition, the system may maintain an index of facial or image data that can be used to map points within a captured image to data stored for known objects. From this process, the system identifies a specific object or content item with which the user is currently interacting.

Continuing in block 330, the system determines the user's identity. Identity may be determined by the user logging into a software application, either manually such as by providing a username and password, or automatically via previously stored security credentials of the user. In some embodiments, the system may recognize the user's computing device, such as via a device identifier, a media access control (MAC) address of networking hardware, or other substantially unique identifier. Knowing the user's device the system can then infer the user associated with the device. The user's identity may be useful for various reasons. Supplemental information attached to objects or content may be restricted based on a user's identity so that only certain users can view certain supplemental information. In such cases, the user's identity is the key to accessing these types of information. Knowing the user's identity also identifies the groups to which the user may belong.

Continuing in block 340, the system determines one or more groups of users of which the identified user is a member. Everyone is a member of various groups in life, which are digitally reflected in the groups managed by the system. These groups may include being a family member to other users, being a coworker to other users, being in a particular demographic group, living in a particular town or neighborhood, and so forth. The system may maintain a database of social circles that identifies the users that are members of each group. The system may get this information from the members of the group, from third party services (e.g., Facebook, Google+, or other social network), by inference from past activity of the user, and so on.

Continuing in block 350, the system optionally determines the user's location where the user is requesting supplemental information. Location may be determined by accessing location hardware of the user's mobile computing device, such as GPS hardware, Wi-Fi hardware, Bluetooth hardware, or other methods. Location information may be relevant at the time of viewing supplemental information attached to an object. For example, a user may request to see supplemental information from other users that visited the same spot (e.g., a historical place, particular store, or other significant location). Location data may also be useful for other reasons. For example, a user entering a grocery store may want to get a list of items requested by members of the user's family.

Continuing in block 360, the system retrieves supplemental information previously associated with the determined object. In some embodiments, the system stores supplemental information in a data store that can be accessed by users of the system. For any particular object, the system may store many instances of supplemental information stored by any number of users that previously encountered the object. In some embodiments, the supplemental information is categorized so that users can view the categories of information available and select a particular category of supplemental information to view to satisfy a particular request.

Continuing in block 370, the system restricts the retrieved supplemental information to prevent the user from viewing supplemental information that the user does not have access to or is not relevant to the user. The restriction may occur on the server or client, based on security and performance goals of any particular implementation of the system. The information may be restricted based on the determined user identity, determined group membership, the determined user location, expiration criteria attached to the supplemental information, and so forth. The restriction removes supplemental information that the user is not authorized to see or that is not relevant based on the user's current circumstances.

Continuing in block 380, the system sends remaining unrestricted supplemental information to the user in response to the user's request. The information may be of various formats and is delivered to the user in a manner appropriate for the format of the information. For example, if the information is text, then the system may simply display the text to the user on the user's computing device. If the information is audiovisual, then the system may playback the information in a media playing application, applet, or embedded control of the user's computing device. Other types of information may be consumed in specific applications applicable to those information types. After block 380, these steps conclude.

The following figures illustrate example displays or user interfaces produced by the information attachment system, in one embodiment, to carry out the features of the system described herein.

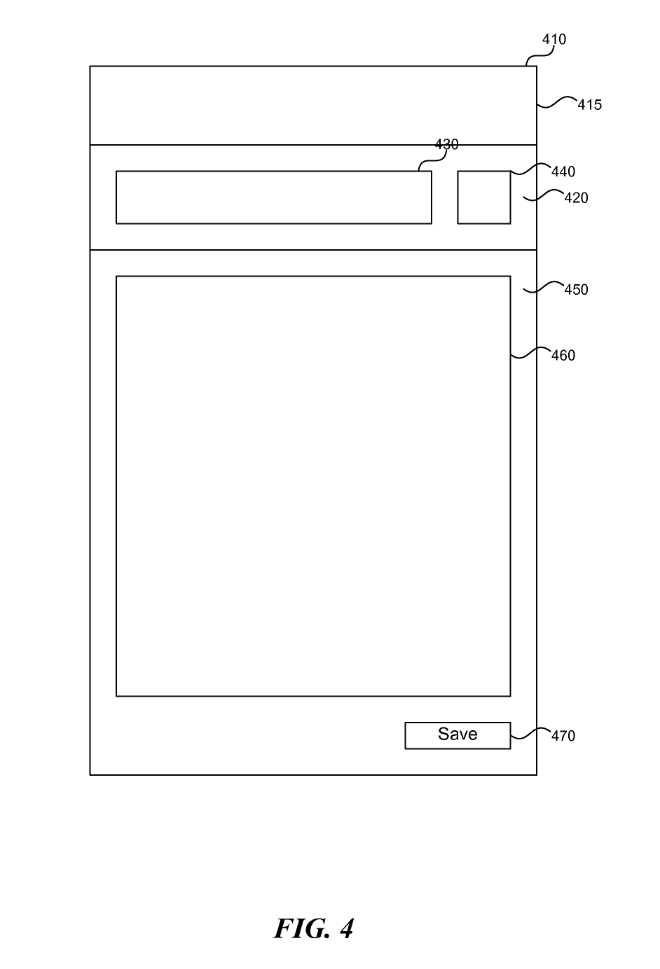

FIG. 4 is a display diagram that illustrates a user interface of the information attachment system for attaching supplemental information to an object or content identified by a marker, in one embodiment. The user interface 410 may be a screen displayed on a mobile or other computing device, such as a smartphone. The user interface 410 includes a live banner region 415, a region 420 that shows the user information about the object or content to which the user is attaching supplemental information, and a region 450 for receiving input from the user. The live banner region 415 provides a banner that, when clicked, brings up many options and actions that can be applied to content. The region 420 may include product or object information 430, such as a picture of the object, brand logo, text, or other information. The region 420 also may include a picture of the marker 440 that the user scanned to begin interacting with the object, such as a QR code. The region 450 includes an input area 460, and a control 470 for saving the supplemental information when the user is done. The input area 460 may receive text input from a virtual or physical keyboard, image input from a camera of the computing device, or any other type of input allowed by the system and receiving by the hardware available to the user. When the user is done adding supplemental information, the user activates the control 470 and the system attaches the supplemental information to the object for designated other users to see. The system may also contain an interface (not shown) through which the user can select advanced properties of the supplemental information, such as a sharing level, location-based triggers, and so forth.

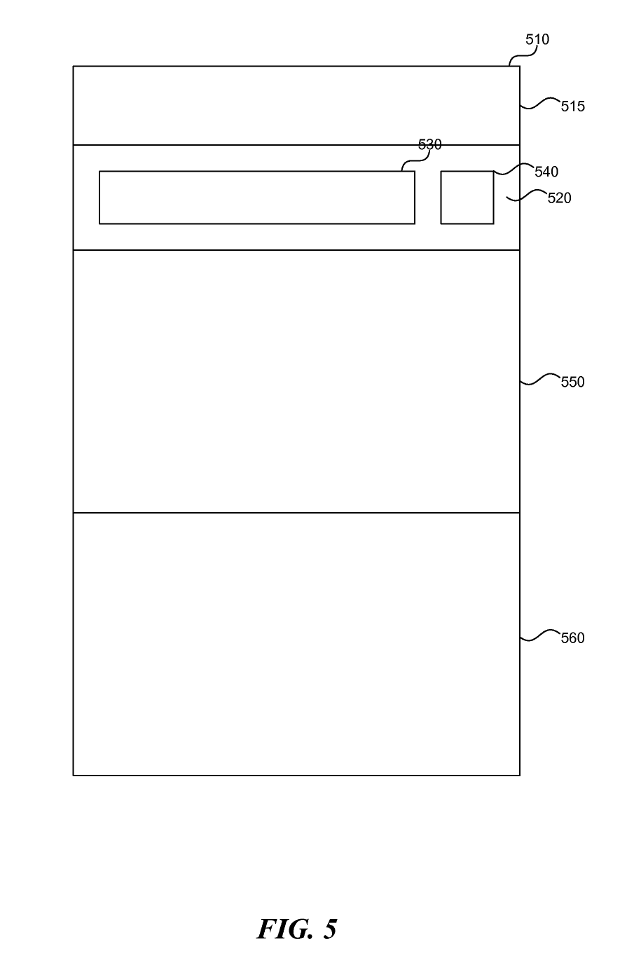

FIG. 5 is a display diagram that illustrates a user interface of the information attachment system for displaying supplemental information attached to an object or content identified by a marker, in one embodiment. The user interface 510 may be a screen displayed on a mobile or other computing device, such as a smartphone. The user interface 510 includes a live banner region 515, a region 520 that shows the user information about the object or content to which the supplemental information is attached, a region 550 for viewing personal (e.g., private) supplemental information attached to the object or content, and a region 560 for viewing public supplemental information attached to the object or content. The live banner region 515 provides a banner that, when clicked, brings up many options and actions that can be applied to content. The region 520 may include product or object information 530, such as a picture of the object, brand logo, text, or other information. The region 520 also may include a picture of the marker 540 that the user scanned to begin interacting with the object, such as a QR code. The regions 550 and 560 may include various types of content or visual representations of that content provided by the user or other users, such as text, pictures, audiovisual content, or any other type of content. The regions 550 and 560 may include lists with numerous elements in each list that the user can scroll through to view.

In some embodiments, the information attachment system provides its own custom type of markers that manufacturers or content authors can attach to their objects and content. These markers may be more useful than existing markers in various ways, such as improving the aesthetic visual qualities of the marker. Bar codes and QR codes, while effective, are not visually attractive and when placed on advertisements or other copy may be distracting and take away space from other content. A marker can be embedded in a visually attractive image, such as a brand logo, in a manner that a machine can read it while a human user is not aware of the embedded information. Thus, the system may use such markers to increase the visual appeal while still providing the information used by the system to positively identify objects and content.

In some embodiments, the information attachment system provides multiple custom applications or vendor-centric focus for viewing and/or adding supplemental information that provide unique context for various interested parties. For example, a reseller of a product may want a custom application that displays a particular type of supplemental information when users run that application. Scanning the same marker from one such application or focus may display different information than scanning the same marker from another application or focus. For example, scanning a marker attached to a car from a tire reseller's application may show the user tires and rims that fit that car, while scanning the same marker from an insurance seller's application may provide insurance quotes for that car. This allows parties to customize the user experience and to create branding around their particular use of attached supplemental information. It also creates a simplified user interface for users, because the context implied by running the application narrows the user's purpose in a manner that allows for a more direct user interface for a particular task.

In some embodiments, the information attachment system displays the original information associated with a marker in addition to the supplemental information described herein. The system is not necessarily meant to replace the original intent of the marker, but rather may supplement that intent with additional social value by attaching information for other purposes. Thus, the original information linked to by a QR code or other marker may be displayed by the system alongside or closely available with supplemental information added by users.

In some embodiments, the information attachment system attaches metadata to supplemental information that may or may not be visually displayed. For example, the system may receive tags, category information, or other relevant metadata from the user or automatically generated by the system. The system can then attach this information so that it can be used to drive unique user experiences when the supplemental information is viewed. Metadata may help organize, categorize, or secure content, or can be used for other purposes specific to a given application for supplemental information.

In some embodiments, the information attachment system includes actionable tools in the supplemental information attached to objects and content. Tools can provide features commonly found in existing services such as Groupon, Survey Monkey, and Evite. Resellers, manufacturers, event coordinators, and others can send coupons and discounts, invitations to special events, or surveys such as satisfaction surveys or comment forms. When a user attaches supplemental information to an existing marker, the system may have a concept of when that data is complete (i.e., when there is a semantic gap), such as included fields that the tool author wants to have filled in (e.g., for a survey or other purpose). The system can then prompt the user to complete any missing fields before the system will accept the provided supplemental information. One example is a tool for receiving insurance quotes. A user that scans a marker associated with the car to get a quote may see some information auto-populated from the marker, such as the car's year, make, and model, and may be prompted to provide other information, such as the user's age, location, and accident history. The tool can then use this information to provide a customized insurance quote.

In addition, parties can define how a user is asked for missing information, allowing them to customize questions to a particular audience. For example, for a group of wine customers that have just taken a tour through Napa Valley, a wine surveyor may ask the question, “how have you liked the red wines at [a particular vineyard]?” This level of question customization is more likely to get a favorable response, because it acknowledges that the surveyor knows something relevant about the person being asked. Questions may be customized based on any number of criteria and may vary based on who is being asked the same question. For example, asking the age of someone older may be more delicately phrased (e.g., “what was your favorite TV show growing up”) than asking the same question to a child.

In some embodiments, the information attachment system provides a concept of dynamic tool application or execution on content on a mobile device based on a location, business, or product focus. This is referred to as Just in Time Tools (JITT). JITT also encompasses a unique mobile interface where multiple columns of vertically scrolling content is overlaid by multiple rows of horizontally scrolling tools and/or filter options that can be extended from the edge of the screen. In some embodiments, these tool/filter bars are extended and lined up with the content columns, and a click of the tool or filter applies it to the column of content to which it is aligned.

For example, consider a mobile device oriented in landscape mode having three columns displayed and three sliders on the right. Each of the three columns can display a different type of information. The sliders provide dimensions along which content can be filtered. For example, the top slider might represent locations or businesses that a user has been to, the middle slider might represent people in the user's social network, and the bottom slider might represent available JITT tools (which may be a tool for showing Facebook posts, a tool for searching, and so forth). By picking a column (e.g., the left column) and a value for each of the three sliders (e.g., location=specific coffee shop, person=my friend Joe, and tool=search), the system can populate the selected column with relevant information, such as messages from a conversation with a particular person at a particular location.

In some embodiments, the information attachment system treats objects conceptually as folder-like containers. An object may have subfolder concepts representing each of the types of supplemental information attached to the objects. Folders may also have permissions that represent the sharing level information attached to each type of supplemental information, as well as other types of metadata described further herein. In such a model, the system may also allow an object (e.g., a coke can) with all of its associated supplemental information to be attached or copied onto another object with viewing rights set appropriately for any particular set of recipients. This becomes an object attached to an object, or conceptually a folder residing inside another folder.

From the foregoing, it will be appreciated that specific embodiments of the information attachment system have been described herein for purposes of illustration, but that various modifications may be made without deviating from the spirit and scope of the invention. Accordingly, the invention is not limited except as by the appended claims.

I/We claim:

1. A computer-implemented method to attach supplemental information to an object using a marker previously associated with the object, the method comprising:
receiving a request from a user to read a marker;
determining an object associated with the marker;
determining the user's identity;
receiving supplemental information from the identified user related to the determined object;
receiving a sharing level from the user that determines which other users will be able to access the received supplemental information; and
attaching the received information to the object by storing the supplemental information and identified object information in a data store where it can be accessed by authorized other users,
wherein the preceding steps are performed by at least one processor.

2. The method of claim 1 wherein receiving the request to read the marker comprises invoking a software application on a mobile computing device, selecting a user interface control for reading a marker, and reading the marker using a digital camera of the computing device.

3. The method of claim 1 wherein a marker is at least one of a barcode, a quick response (QR) code, a product identifier, a recognized image, a recognized face, a Wi-Fi service set identifier (SSID), and geo-location information.

4. The method of claim 1 wherein determining the object associated with the marker comprises accessing a data store that stores a mapping of markers to objects and looking up the marker in the data store.

5. The method of claim 1 wherein determining the user's identity comprises accessing a stored user profile associated with the user that includes associated user information.

6. The method of claim 1 wherein receiving supplemental information comprises receiving one or more formats of information including at least one of text, audio information, video information, and image information.

7. The method of claim 1 wherein receiving supplemental information comprises receiving information through hardware of a mobile computing device associated with the identified user.

8. The method of claim 1 wherein receiving supplemental information comprises guiding the user to provide a set of predetermined information requested by another party associated with the object.

9. The method of claim 1 wherein receiving the sharing level comprises defining received supplemental information as public, so that it is accessible to any other user, or private, so that it is restricted to access by one or more identified users.

10. The method of claim 1 wherein receiving the sharing level comprises receiving an identified of a group of users that are permitted to access the received supplemental information.

11. The method of claim 1 further comprising determining the user's location where the supplemental information was received and storing the location in association with the received supplemental information.

12. The method of claim 1 wherein attaching the received information to the object comprises storing the received sharing level in association with the received supplemental information.

13. A computer system for attaching supplemental information to objects and content using markers, the system comprising:
a processor and memory configured to execute software instructions embodied within the following components;
a marker identification component that finds and identifies one or more markers near a user that identify particular objects and content;
a marker reading component that determines one or more objects or content items with which identified markers are associated;
an information receiving component that receives supplemental information from a user of the system that the user wants to associate with an identified object or content item;
an information attachment component that associates the supplemental information received from the user with the identified object or content item to attach and create a direct association between the two;
a sharing restriction component that defines a sharing level for received supplemental information that determines which other users of the system will be allowed by the system to view the received supplemental information;
a location identification component that determines a user's location and provides this information for determining how supplemental information is shared with other users of the system;
a group management component that manages social circles of users that have one or more connections to each other and manages sharing of received supplemental information within each managed social circle; and
a user profile component that stores and provides access to profile information for each user of the system.

14. The system of claim 13 wherein the marker identification component continually looks for markers near the user using digital image capture hardware associated with the computing system.

15. The system of claim 13 wherein the marker reading component extracts information embedded within the marker itself to identify the object or content item with which the marker is associated.

16. The system of claim 13 wherein the information attachment component allows subsequent users of the system that identify the same object to view supplemental information shared by previous users by storing the supplemental information in a data store accessible by users of the system.

17. The system of claim 13 wherein the sharing restriction component stores with each instance of supplemental information restriction data that indicates how widely the user providing the information wants the information shared with other users, wherein the restriction data includes at least one of restrictions on users that may access the supplemental information, a time period during which the supplemental information can be accessed, and locations from which the supplemental information can be accessed.

18. The system of claim 13 wherein the group management component accesses a third party social network to identify at least some social circles.

19. A computer-readable storage medium comprising instructions for controlling a computer system to read supplemental information attached to an object, wherein the instructions, upon execution, cause a processor to perform actions comprising:
receiving a request from a user to read a marker;
determining an object associated with the marker;
determining the user's identity;
determining one or more groups of users of which the identified user is a member;
retrieving supplemental information previously associated with the determined object;
restricting the retrieved supplemental information to prevent the user from viewing supplemental information that the user does not have access to or that is not relevant to the user; and
sending remaining unrestricted supplemental information to the user in response to the user's request.

20. The medium of claim 19 further comprising determining the user's location where the user is requesting supplemental information and restricting provided supplemental information based on the user's location.
